(19) United States
(12) Patent Application Publication
(10) Pub. No.: US 2012/0280037 A1
(43) Pub. Date: Nov. 8, 2012

(54) Credit Card with E-paper Display for Advertisement and with Optical Communication and Power Transfer Modules

(76) Inventor: Yang Pan, Singapore (SG)

(21) Appl. No.: 13/549,467

(22) Filed: Jul. 14, 2012

Related U.S. Application Data
(63) Continuation-in-part of application No. 12/701,554, filed on Feb. 6, 2010.

(51) Int. Cl. G06Q 90/00

(52) U.S. Cl. 235/380

(57) ABSTRACT

A novel credit or charging card is disclosed. According to one implementation, the card comprises an e-paper type of display on at least one of two surfaces of the card. An advertising message may be displayed. The advertising message may be replaced by a new one when the card is connected to a card reader. The advertising message may be selected based upon a data file stored in a storage unit of the card. The data file includes a purchase history of the user using the card. According to one embodiment of the invention, the card and the reader are coupled through an optical power transfer module and an optical communication module. Operations of the card are powered by optical energy transmitted from the card reader.

### CROSS-REFERENCE TO RELATED APPLICATIONS

The present application is a continuation in part of the application Ser. No. 12/701,554.

### BACKGROUND

1. Field of Invention

This invention relates generally to advertising. More specifically, the invention describes an advertising system based on an improved credit card with an e-paper display.

2. Description of Prior Art

Consumer purchasing worldwide extends into the trillions of dollars annually. Much of this commercial activity is a by-product of massive advertisement efforts whose annual cost reaches well into high billions of dollars. A significant influence on developing effective advertising is to deliver advertising messages to targeted customers.

Advertising messages delivered to the customers by using communication networks and mobile devices have become more popular in recent years. It increases the effectiveness of an advertisement by identifying a user's personal profile and his or her locations.

The use of financial transaction cards such as, for example, credit cards have become common place in virtually every aspect of consumerism. It is not un-usual that a person carries multiple cards in his or her wallet. The credit card operators possess valuable data about a user's purchasing profile. The use of the data has not been fully explored partly due to concerns about privacy. The surfaces of the cards are typically printed with the logo of the card such as “Visa” or “Master”. Some cards may be printed with advertising messages that are typically indifferent to different users.

Therefore, it is desirable to employ the financial transaction cards to deliver targeted advertising messages by utilizing the user's personal profile, purchase history and locations.

### SUMMARY OF THE INVENTION

It is an object of the present invention to provide an improved advertising system to users of financial transaction cards.

An advertising message is delivered from a card reader to the card and is displayed on the card. The advertising message may be selected based upon a purchase history of the user using the card. A data file including the purchase history may be stored in a file storage unit of the card. The advertising message may further be selected based upon a location that the card and the card reader are connected in a financial transaction.

According to one embodiment of the present invention, a credit card with e-paper display is used as an exemplary case of the present invention. The advertising system comprises a credit card, a card reader, a server operated by a card operator and an advertiser. The e-paper can display a message and/or an image without consuming electrical power when the content is not changed.

The credit card and the card reader may be coupled through a power transfer module and a communication module. Operations of the credit card may be powered by the power transferred from the card reader. Data may be transferred from the card reader to the card or vice versa through the communication module.

In one implementation, the communication module is a radio-frequency (RF) communication module.

In another implementation, the communication module is an optical communication module.

In yet another implementation, the communication module is a wired communication link.

In one implementation, the power transfer module is a RF power transfer module.

In another implementation, the power transfer module is an optical power transfer module including a light source in the card reader and an optical power receiver in the card.

In yet another implementation, the power transfer module is a wired power transfer module.

In one implementation, the card may include an on card power supply.

In another implementation, the card may include a light-to-electrical power converter such as, for example, a photo-detector or solar cell. When the card and the card reader are decoupled, the light-to-electrical power converter may receive energy in optical form. The energy in optical form is converted into electrical power and is stored in an energy storage unit such as, for example, a capacitor. The stored energy may be employed to replace the displayed advertising message with a new one selected from advertising messages stored in the file storage unit of the card.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram illustrating an exemplary advertising system based upon the present invention;

FIG. 2 is a schematic diagram illustrating exemplarily that advertising messages are displayed on both surfaces of a credit card with e-paper displays;

FIG. 3 is a schematic diagram illustrating the connection between the card and the card reader;

FIG. 4A is a schematic diagram illustrating functional blocks of the credit card and the card readers based upon one embodiment of the present invention;

FIG. 4B is a schematic diagram illustrating functional blocks of the credit card with an on card power supply;

FIG. 5 is a flowchart illustrating the operation of the advertising system;

FIG. 6 is a flowchart illustrating a process that a targeted advertising message is delivered to the user using the advertising system;

FIGS. 7A-B are schematic diagrams illustrating functional blocks of the credit card and the card readers based upon another embodiment of the present invention with a purchase history of the user stored in a storage unit of the card;

FIGS. 8A-B are schematic diagrams illustrating functional blocks of the credit card and the card readers based upon yet another embodiment of the present invention with an optical communication module and an optical power transfer module;

FIG. 9 is a flowchart illustrating an exemplary process that data is transferred from the card reader to the card through an optical communication module;

FIG. 10 is a schematic diagram illustrating a light-to-electrical power converter is used to store energy and to replace displayed advertising message.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

The present disclosure uses a credit card with an e-paper display as an exemplary case to illustrate the inventive concept. The inventive concept may be applied to any other financial transaction cards and to any other types of displays, which do not consume electrical power when the displayed message or image is not altered.

A credit card is part of a system of payments named after the small plastic card issued to users of the system. It is a card entitling its holder to buy goods and services based on the holder's promise to pay for these goods and services. The issuer or the operator of the card grants a line of credit to the customer or the user from which the user can borrow money for the payment to a merchant or as cash advance to the user. The present invention can also be applied to other type of financial transaction cards such as the charging cards. A credit card is different from a charging card, where a charging card requires the balance to be paid in full each month. In contrast, credit cards allow the consumers to ‘revolve’ their balance, at the cost of having interest charged. Most credit cards are issued by credit card operators such as local banks or credit unions, and are the shape and size specified by the ISO/IEC 7810 standard as ID-1. This is defined as 85.60×53.98 mm in size.

The use of the credit card comprises an authorization step. The user pays for the purchase and the merchant submits the transaction to the operator. Electronic verification systems allow merchants to verify that the card is valid and the credit card user has sufficient credit to cover the purchase in a few seconds, allowing the verification to happen at time of purchase. The verification is performed using a credit card payment terminal or a credit card reader with a communication link to the server operated by the operator through a communication network. Data from the card is obtained from a magnetic stripe or chip on the card.

E-paper is a display technology designed to mimic the appearance of ordinary ink on paper. Unlike a conventional LCD (Liquid Crystal Display), which uses a backlight to illuminate its pixels, e-paper reflects light like ordinary paper and is capable of holding text and images indefinitely without consuming electrical power, while allowing the image to be changed later.

The advertising messages may include a text message and/or an image which are suitable to be displayed on a relatively small display screen defined by the size of the credit card.

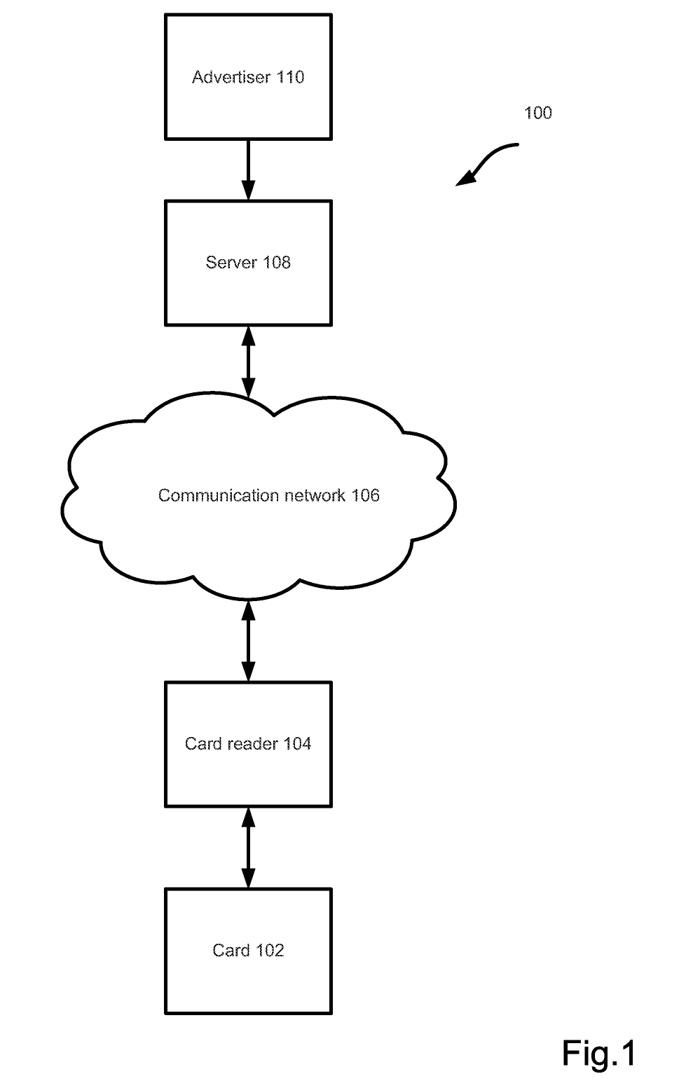

FIG. 1 is a schematic diagram illustrating an exemplary advertising system based on a credit card payment system. The system 100 comprises a credit card 102 and a card reader 104. Although one card and one card reader are depicted in the figure, the inventive concept can be extended to multiple cards and multiple card readers. The card 102 and the card reader 104 may be connectable through a wireless communication means such as for example through a RFID (Radio Frequency Identification) type of link. The card 102 and the card reader 104 may also be connectable through hard-wired connection. A communication network 106 connects the card reader to the server 108 operated by the card operator. The card operator may be an issuing bank or a credit union. The communication network 106 may be the Internet. The communication network 106 may also be public telephone networks. The server 108 may be connected to at least one advertiser 110. The advertiser 110 uploads advertising messages to the server 108.

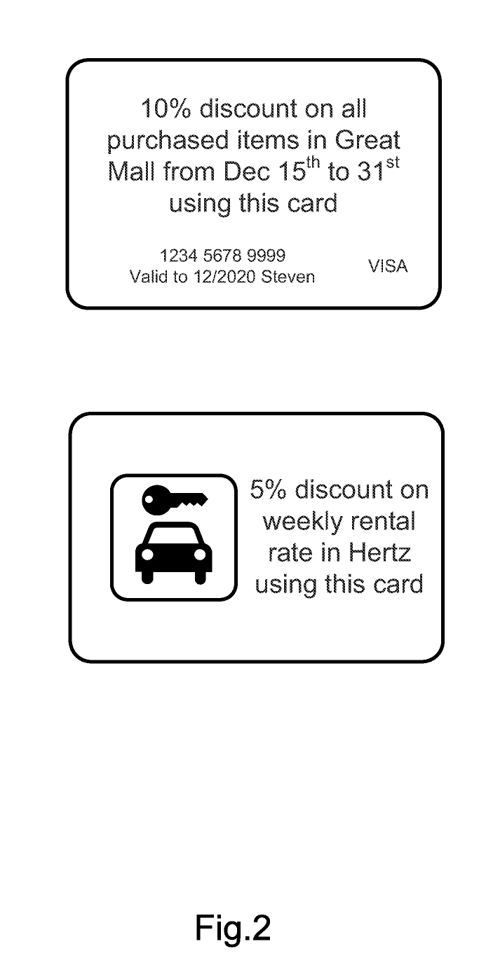

FIG. 2 is a schematic diagram illustrating exemplarily that advertising messages are displayed on surfaces of the credit card with e-paper displays. The advertising messages or images may be displayed on one surface of the card. The advertising messages or images may also be displayed on both surfaces of the card. The displayed messages or images may include a promotion specifically related to using the card as illustrated. The e-paper display is reflective and no electrical power is consumed if the messages or the images are not altered. The advertising messages may be selected based on the user's personal profile, the purchase history and the location as defined by the card reader when the message is delivered.

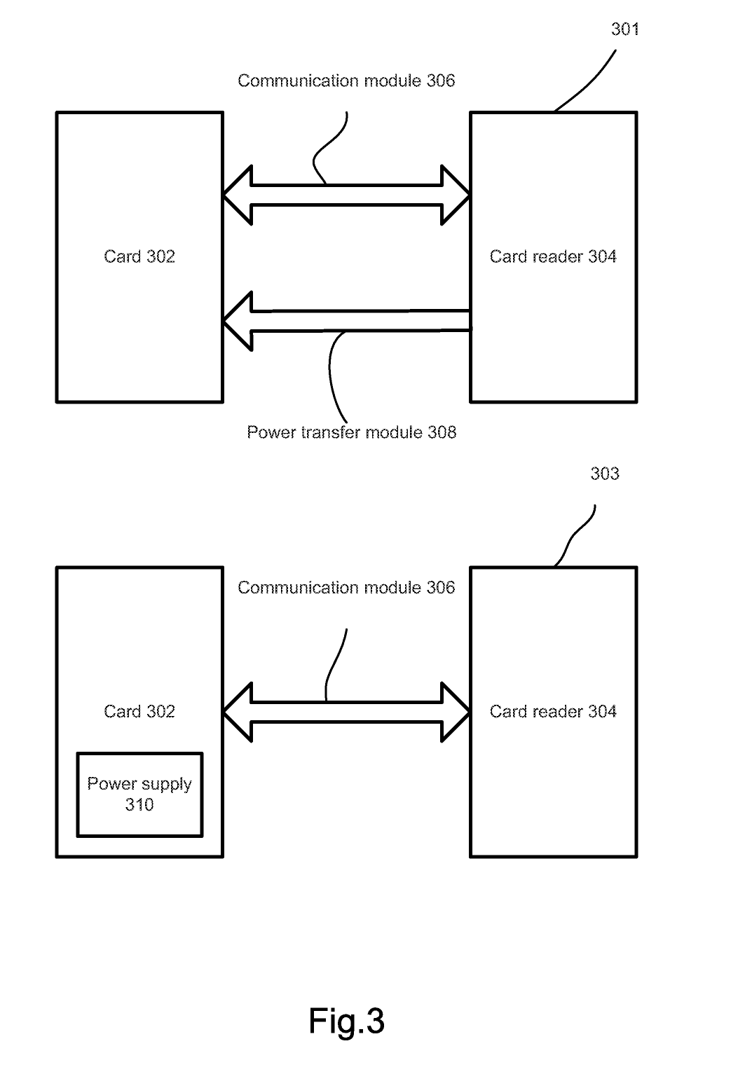

FIG. 3 is a schematic diagram illustrating the connection between the card and the card reader. According to one embodiment of the present invention as illustrated in 301, the card 302 and the card reader 304 are connected through a communication module 306 and a power transfer module 308. According to one aspect of the invention, the communication module may be a wireless communication link such as the RFID type of communication link. The other wireless communication link such as Bluetooth, ZigBee and WiFi may also be employed. The communication module 306 may also be a hard-wired communication channel when the card 302 and the reader 304 are connected.

According to one aspect of the invention, the power transfer module 308 may be a RF power transfer means similar to the one used in RFID system. The card reader 304 comprises a RF power generator and the card 302 comprises a RF power receiver. The received power is used to refresh the displayed content of the e-paper displays.

The power transfer module 308 may also be implemented using optical method. The card reader 304 may comprise a light source and the card may include a photodiode. The photodiode receives the light beam emitted from the reader and converts the received photo energy into electrical power based on the well known photovoltaic effects.

According to another embodiment of the present invention as illustrated in 303, the card 302 comprises an on card power supply 310. The power supply 310 may be a miniature battery. The power supply 310 may also be a small solar panel on at least one of the two surfaces of the card.

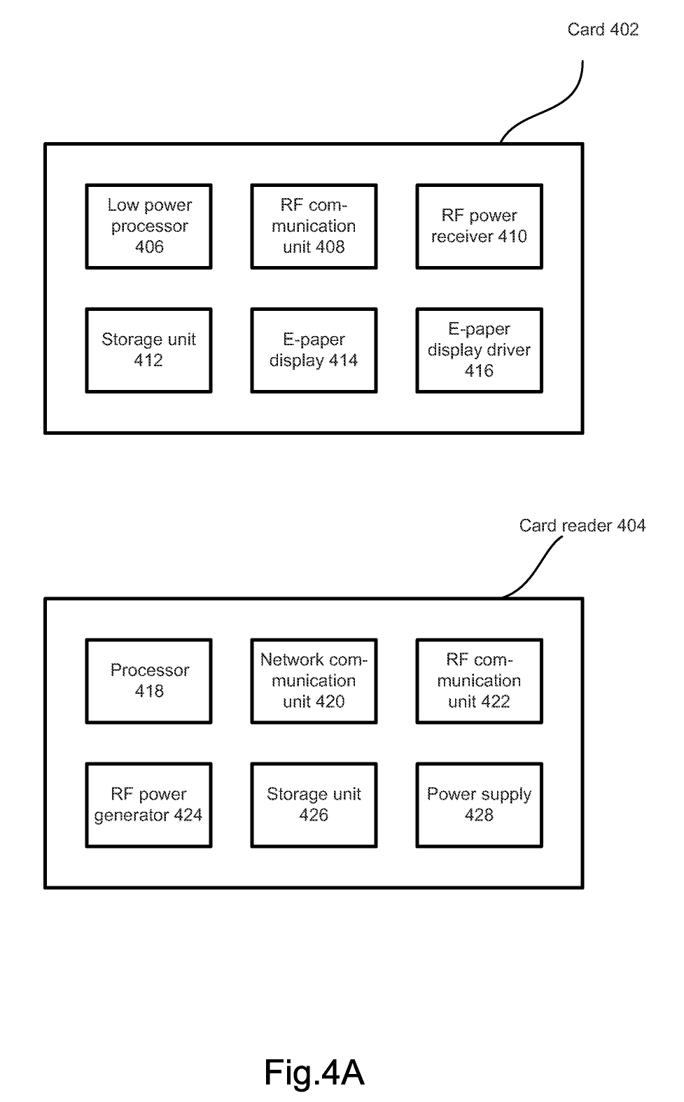

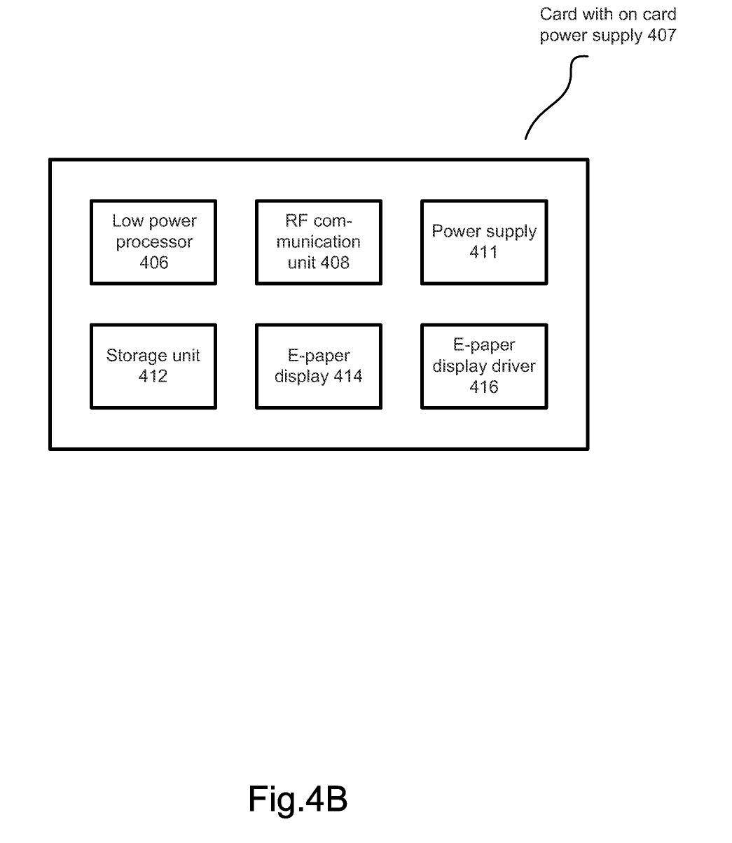

FIG. 4A is a schematic diagram illustrating functional blocks of the credit card 402 and the card reader 404 based upon the present invention. The block 402 is an exemplary implementation of the credit card 302. The exemplary card 402 comprises a low power processor 406 pertaining to control the operations of the card 402. 406 may further comprise a microprocessor or microcontroller. The card 402 further comprises a RF communication unit 408 and a RF power receiver 410. The communication unit 408 and the power receiver 410 may be implemented according to a conventional RFID system. The RF power receiver 410 receives the RF power generated from the reader 404 and rectifies the received power into a DC component to power the operations of the card 402. The card 402 may further include a storage unit 412 for storing data. The storage unit may be a nonvolatile memory such as a flash memory or an EEPROM. The card 402 further comprises a display 414. The display 414 may be a display with an electrically replaceable content on one surface of the card. The display 414 may be on both surfaces of the card. The display 414 is e-paper type of displays according to the preferred embodiment. The card 402 may also include a display driver 416.

The card reader 404 comprises a processor 418 pertaining to control the operations of the reader. The card reader 404 further comprises a network communication unit 420 for connecting the reader 404 and the server operated by the card operator through a communication network. The card reader 404 further comprises a RF communication unit 422 for connecting the reader 404 and the card 402. A RF power generator 424 is also included in 404. The card reader 404 further comprises a storage unit 426 and a power supply 428.

FIG. 4B is another implementation of the credit card based on the present inventive concept. The card 407 includes an on card power supply 411. The power supply 411 may be a miniature battery. Because the e-paper displays consume electrical power only when they change their display contents, the battery may last very long time. The power supply may also be a solar panel on one of the two surfaces of the card. The credit card 407 with on card power supply may refresh its displays controlled by the low power processor on a regular base. The advertising messages may be stored in the storage unit 412. The messages may be downloaded from the card reader when the card and the reader are connected.

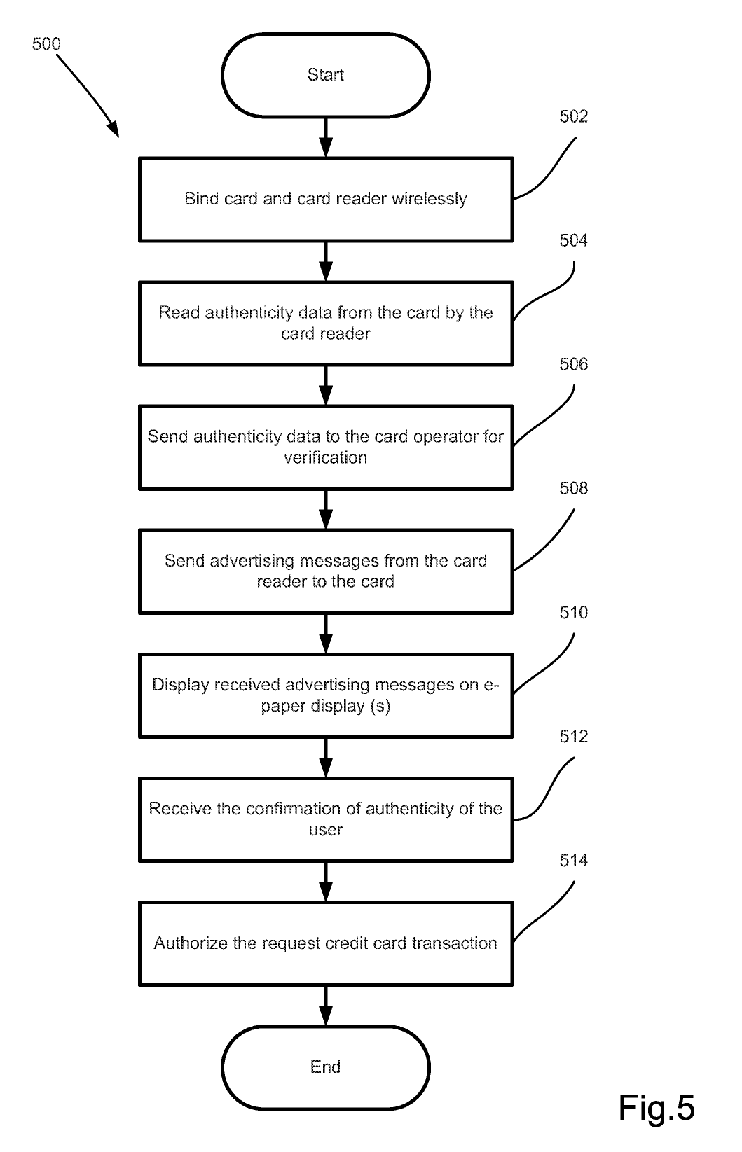

FIG. 5 is a flowchart illustrating the operation of the advertising system. Process 500 starts with step 502 that the credit card and the card reader are connected wirelessly such as through a RF type of link. The authenticity data in the card is read by the card reader in step 504. The received data is then sent to the card operator for verification in step 506. While the reader is waiting for the verification from the operator, the reader sends advertising messages to the card in step 508. The received advertising messages are displayed on e-paper displays in step 510. The operation may be controlled by the low power processor of the card and the display driver. The card reader finally receives the confirmation of the authenticity of the user in step 512 and the credit card transaction for the purchase is completed in step 514. It should be noted that the credit card may also fail the authenticity check and the transaction will not be authorized when it happens.

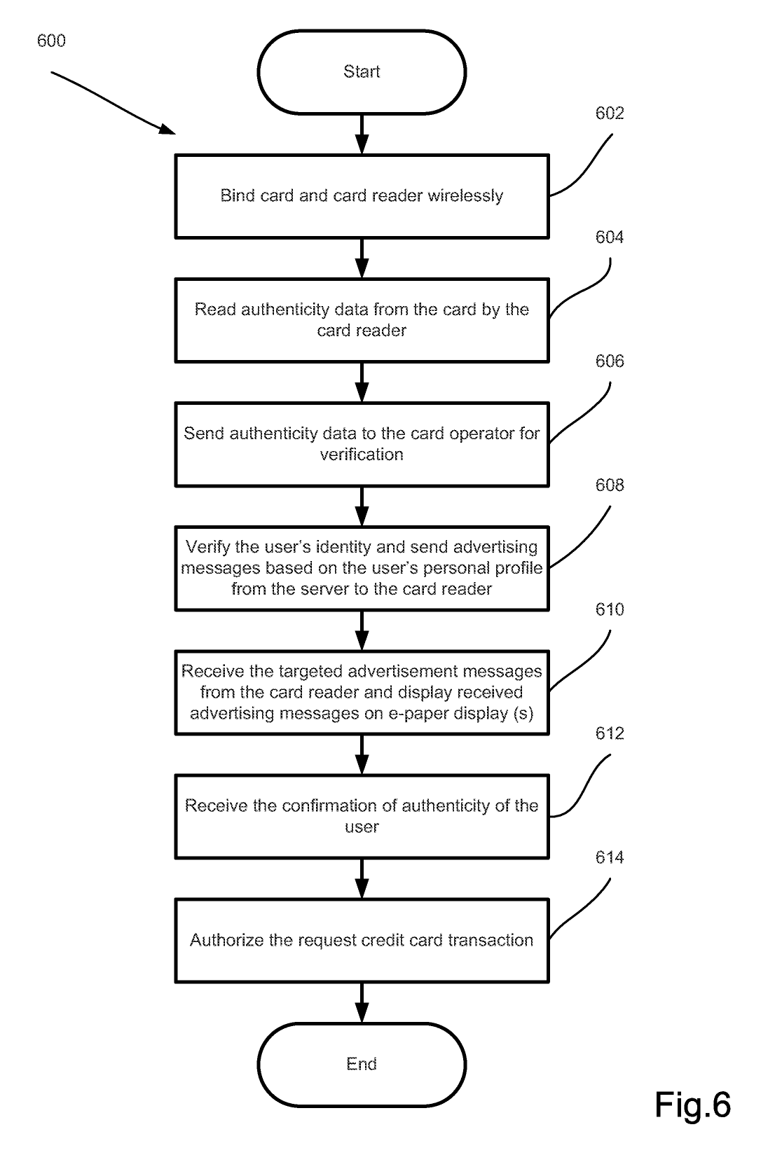

FIG. 6 is a flowchart illustrating a process that a targeted advertising message is delivered to the user using the advertising system. Process 600 starts with step 602 that the credit card and the card reader are connected wirelessly such as through a RF type of link. The authenticity data in the card is read by the card reader in step 604. The received data is then sent to the card operator for verification in step 606. The user's authenticity is determined in step 608 and advertising messages based on the user's personal profile, purchase history and the location of the reader are sent to the card reader accordingly. The messages are received in step 610 by the card reader. The messages are sent to the card subsequently and are displayed on the e-paper displays. In the same time, the reader receives the confirmation of the authenticity of the user in step 612 and authorizes the transaction in step 614.

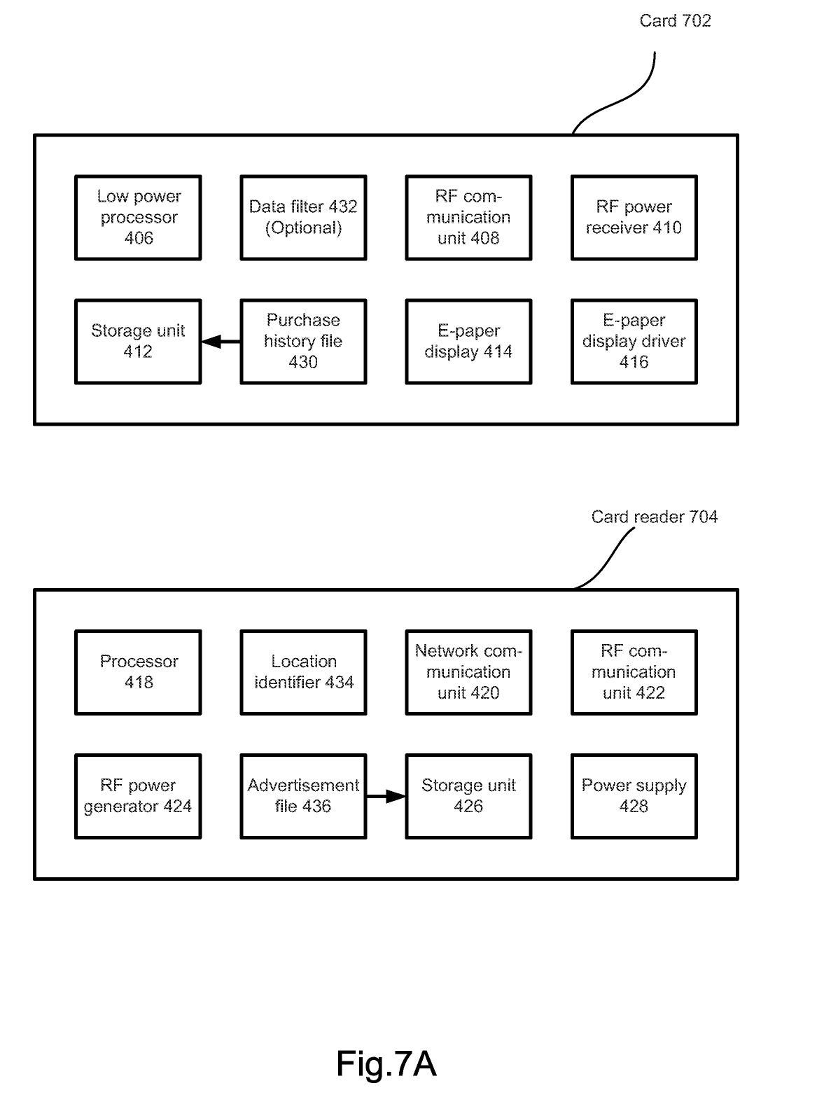

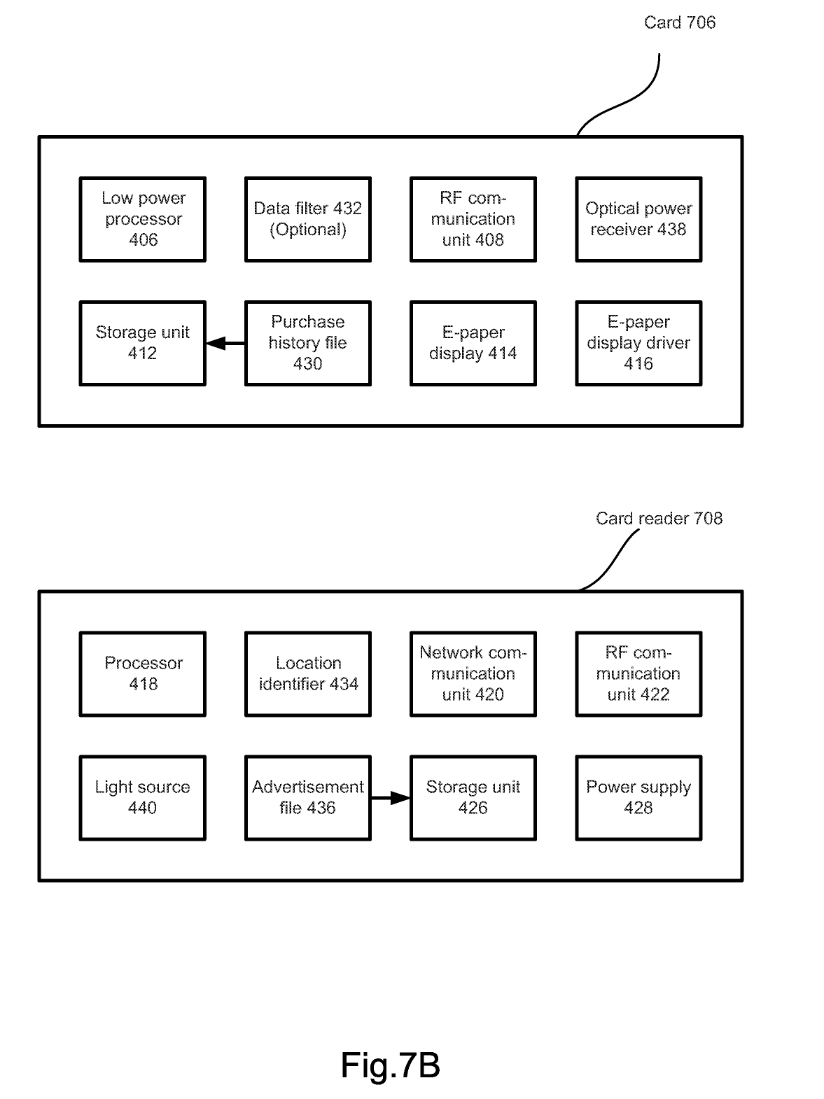

FIG. 7A is a schematic diagram illustrating functional blocks of the credit card and the card readers based upon another embodiment of the present invention. An exemplary card 702 includes a purchase history file 430. Data file 430 may be an accumulated record of purchase events of the user over a period of time such as, for example, a year. Data file 430 may be updated when each time the user completes a financial transaction using the card. Low power processor 406 may determine a duration that purchase events are recorded. Low power processor 406 may also delete certain purchase events based upon predetermined rules. A data filter 432 may be used to remove a portion of data in data file 430 before the data file is transferred to the card reader through the communication module.

An advertising message may be selected by processor 418 in an exemplary card reader 704 in accordance with the received data file 430. Card reader 704 may further include a location identifier 434 pertaining to determining a location that a financial transaction is completed using card 702 and card reader 704. In one implementation, location identifier 434 may be a Global Positioning System (GPS). In another implementation, location identifier 434 is a location determining means by the use of a wireless communication network. In another implementation, location identifier 434 is operated as a user input menu for a user of the card reader to input the location.

The advertising message may be determined by data file 430 in combination of the location determined by location identifier 434. Advertising messages including location sensitive messages may be included in an advertisement file 436. In one implementation, advertisement file 436 is stored in storage unit 426 of card reader 704. Card reader may be connected to a server 108 in a communication network 106. Advertisement file 436 may also be stored in server 108. Advertisement file 436 may be updated by server 108 in accordance with a predetermined frequency.

Identity of the user of card 702 may also be determined during a financial transaction when the card and the card reader are connected. Advertising message may further be determined by the identity of the user. The user's identity may be associated with a personal profile. The personal profile may be stored in server 108 of network 106. The personal profile may also be stored in storage unit 412 of card 702.

It should be noted that present inventive concept may be implemented in various different manners as obvious to one with ordinary skill in the art. For example, location identifier 434 may or may not be included in card reader 704. Purchase history file 430 may be stored in server 108 of communication network 106. All such variations fall into the scope of the present inventive concept.

In another implementation as shown in FIG. 7B, power transfer module includes an optical power receiver 438 in exemplary card 706 and a light source 440 in exemplary card reader 708. A light beam is generated by light source 440. The light beam is received by optical power receiver 438 and is converted into electrical power for powering operations of card 706 that does not include an on card power supply. Light source 440 may include but is not limited to a laser or a Light Emitting Diode (LED). Optical power receiver 438 may include but is not limited to a photodiode and a solar cell.

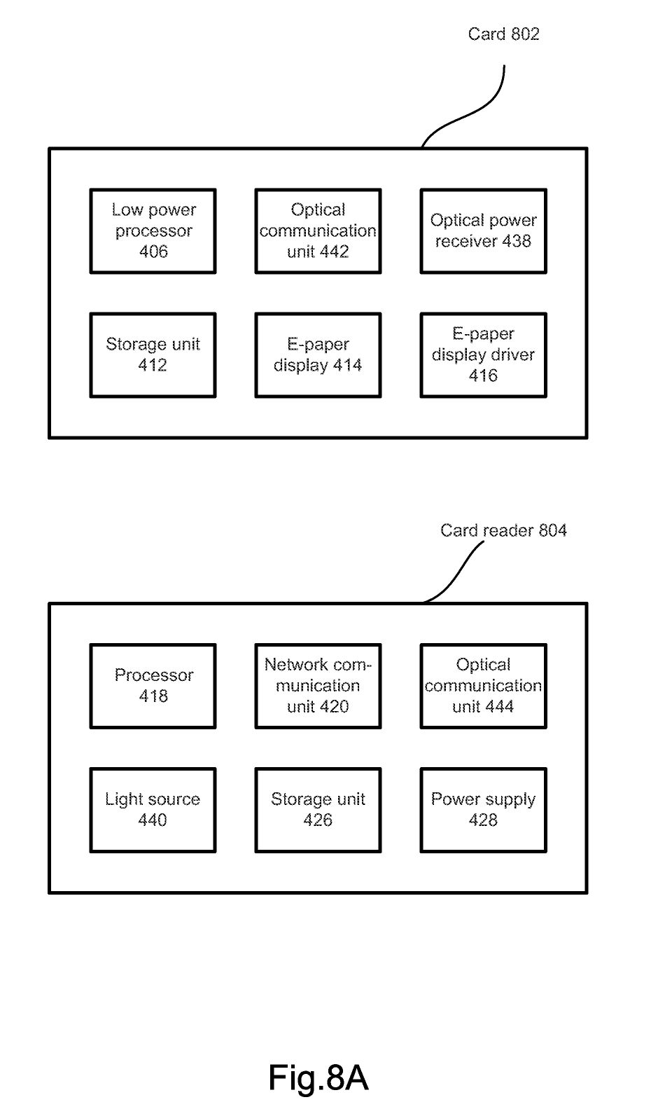

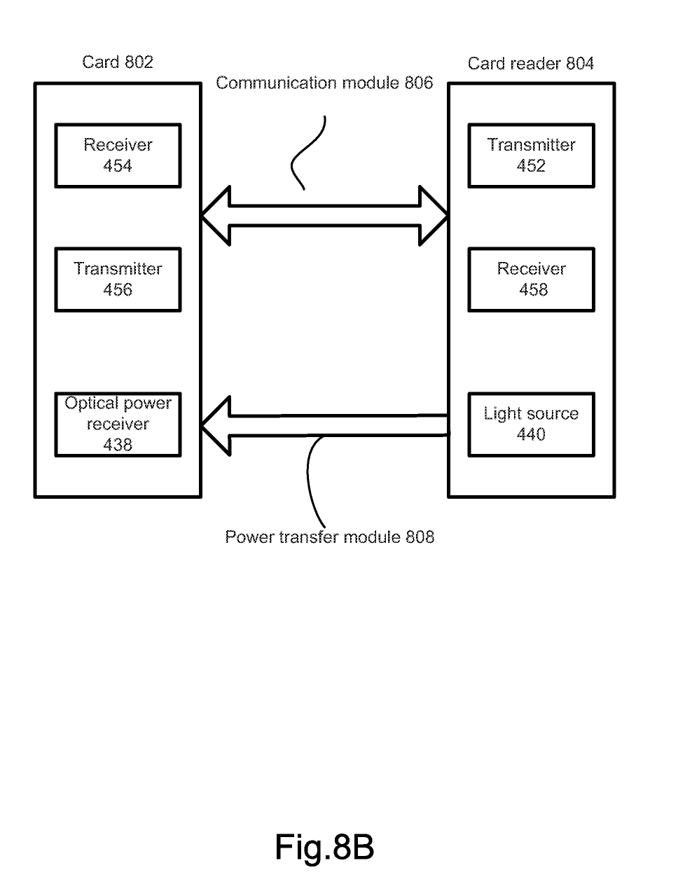

FIGS. 8A-B are schematic diagrams illustrating functional blocks of the credit card 802 and the card reader 804 based upon yet another embodiment of the present invention. Both power transfer module and communication module are implemented based upon optical means. As shown in FIG. 8A, the power transfer module comprises an optical power receiver 438 in card 802 and a light source 440 in card reader 804. Light source 440 includes a laser or a LED. Optical power receiver 438 includes a photodiode or a solar cell. The communication module includes an optical communication unit 442 in card 802 and another optical communication unit 444 in card reader 804. As further illustrated in FIG. 8B, communication module 806 further comprises a transmitter 452 and a receiver 458 in card reader 804 and a receiver 454 and a transmitter 456 in card 802. In an exemplary implementation, transmitters 452/456 are LED's and receivers 454/458 are photodiodes. Data are transmitted between the card 802 and the card reader 804 through modulated light beams emitted from LED's.

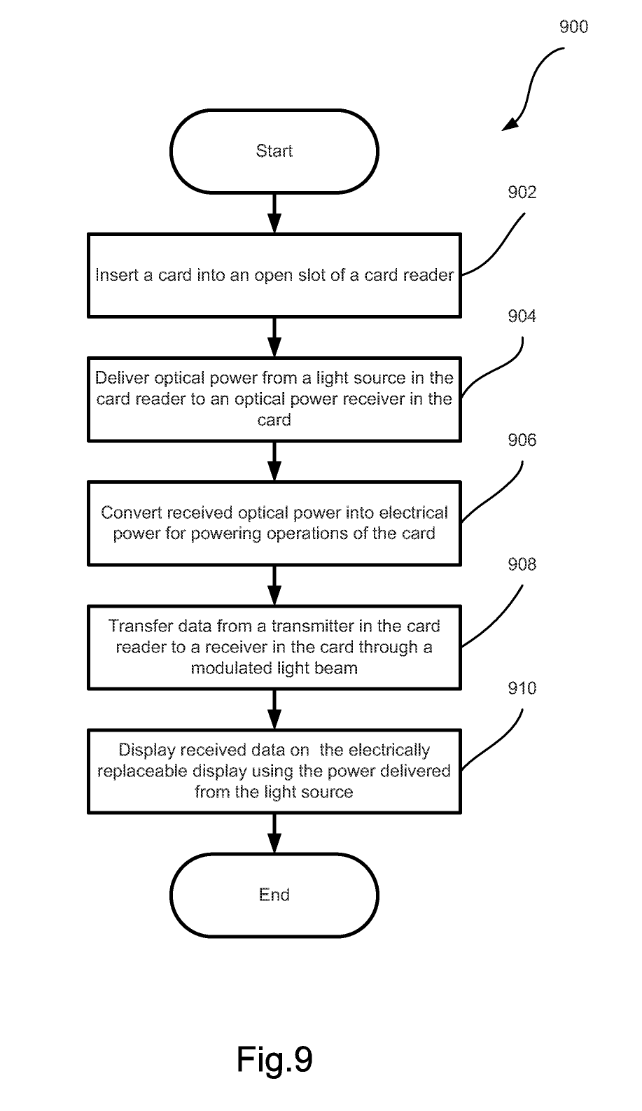

FIG. 9 is a flowchart illustrating an exemplary process that data is transferred from the card reader to the card through an optical communication module. An exemplary process 900 starts with step 902 that card 802 is inserted into an open slot of card reader 804. Alignments for transmitter 452 and receiver 454, transmitter 456 and receiver 458 and light source 440 and optical power receiver 438 are required. Optical power in a form of light beam is delivered from light source 440 in card reader 804 to optical power receiver 438 in card 802 in step 904. Received optical power is converted to electrical power in step 906 by the use of optical power receiver 438. Optical power receiver 438 includes a photodiode in one implementation. The electrical power is utilized to power operations of card 802 that does not include an on card power supply. In step 908, data such as, for example, an advertising message is transferred from card reader 804 to card 802 through transmitter 452 and receiver 454. In one implementation transmitter 452 is a LED and receiver 454 is a photodiode. The data is transferred through a modulated light beam emitted from the LED and is received by the photodiode. In step 910, received data is displaced on the electrically replaceable display such as, for example, an e-paper type of display. In some implementation, received data may be stored in the storage unit of card 802 and may not be displayed. Although it is not an essential step of the operation, data may be transferred from card 802 to card reader 804 through transmitter 456 and receiver 458. In one implementation, transmitter 456 is a LED and receiver 456 is a photodiode. A data file including the user's purchase history using the card may be transferred from card 802 to card reader 804 for selecting a targeted advertising message for the user.

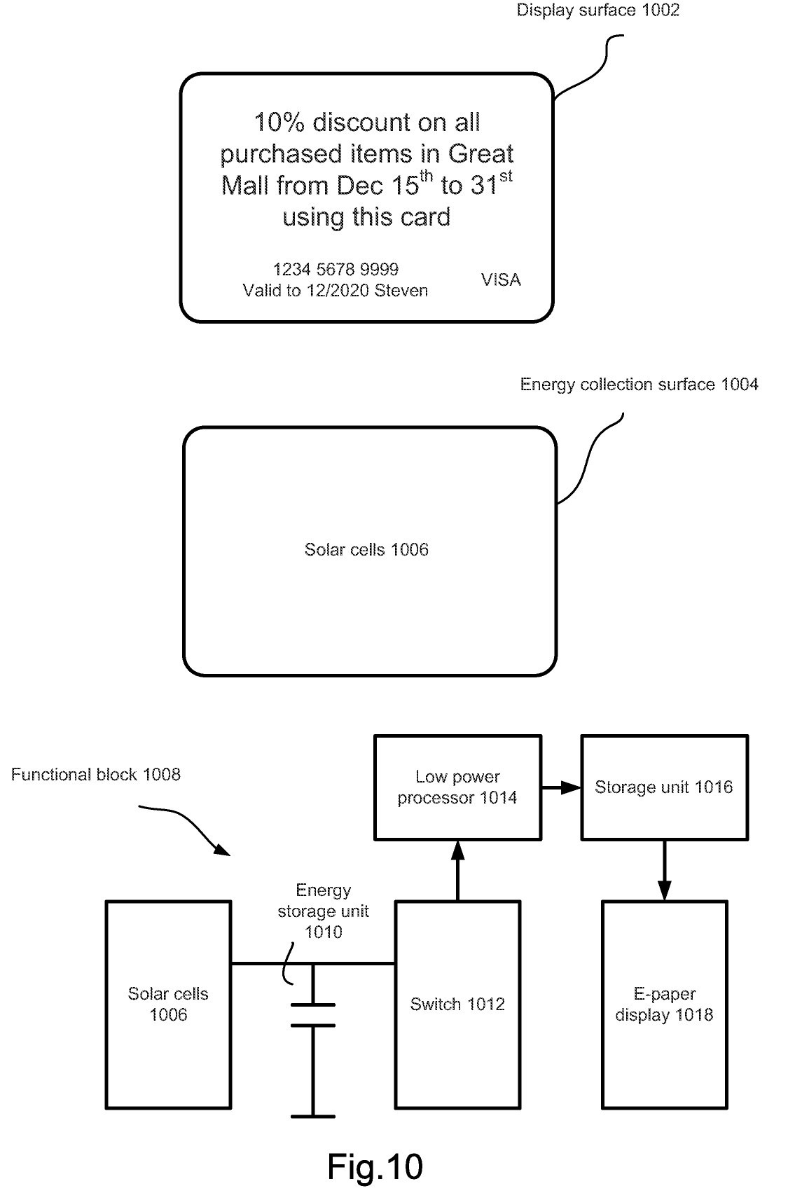

FIG. 10 is a schematic diagram illustrating a light-to-electrical power converter is used to store energy and to replace displayed advertising message on the e-paper display. An exemplary credit card includes an e-paper type of display on a display surface 1002 of the credit card. The credit card further includes an energy collection surface 1004. In an exemplary implementation, solar cells 1006 are placed on energy collection surface 1004. In another implementation, display surface 1002 may include a solar cell or photodiode. Functional block 1008 includes solar cells 1006 for collecting optical energy from the ambient. The optical energy may be solar energy. The optical energy may also be a light beam emitted from a laser, a LED or other man made lighting devices. An energy storage unit 1010 is used to store collected energy by solar cells 1006. In an exemplary case, energy storage unit 1010 may be a capacitor for storing charges generated from solar cells 1006. An output of energy storage unit 1010 is connected to a switch 1012. Switch 1012 is turned on only if stored energy in energy storage unit 1010 exceeds a predetermined value that is sufficient for a low power processor 1014 to execute an instruction to fetch a new advertising message from storage unit 1016 and to replace the displayed advertising message on the e-paper display 1018 by the fetched new message.

1. An advertising message delivery system comprising:
a. a card reader and a financial transaction card, wherein the card reader and the card can be coupled through an optical communication module and an optical power transfer module; and
b. an electrically replaceable display on one of two surfaces of the card pertaining to displaying an advertising message transferred from the card reader through the optical communication module,
wherein operations of the card is powered by power transferred from the card reader through the optical power transfer module when the card and the card reader are coupled.

2. The system as recited in claim 1, wherein said optical communication module further comprises:
a. a transmitter and a receiver in the card reader; and
b. a transmitter and a receiver in the card.

3. The system as recited in claim 2, wherein said transmitters further comprise light emitting diodes.

4. The system as recited in claim 2, wherein said receivers further comprise photodiodes.

5. The system as recited in claim 1, wherein said optical power transfer module further comprises:
a. a light source in the card reader; and
b. an optical power receiver in the card.

6. The system as recited in claim 5, wherein said light source further comprises a laser.

7. The system as recited in claim 5, wherein said light source further comprises a light emitting diode.

8. The system as recited in claim 5, wherein said optical power receiver further comprises photodiodes.

9. The system as recited in claim 5, wherein said light source and said optical power receiver are employed to transfer data from the card reader to the card.

10. The system as recited in claim 1, wherein said electrically replaceable display further comprises an e-paper type of display.

11. The system as recited in claim 1, wherein said card further comprises a file storage unit for storing a data file including a purchase history of a user using the card.

12. The system as recited in claim 1, wherein said card further comprises a light-to-electrical power converter and an energy storage unit pertaining to accumulating energy for replacing displayed advertising message on the electrically replaceable display by a new advertising message.

13. An advertising message delivery system comprising:
a. a card reader and a financial transaction card, wherein said card reader and card can be coupled through a communication module and a power transfer module;
b. an electrically replaceable display on one of two surfaces of the card; and
c. a light-to-electrical power converter on one of the two surfaces of the card.

14. The system as recited in claim 13, wherein said card further comprises a processor and a file storage unit pertaining to storing advertising messages transferred from the card reader through the communication module.

15. The system as recited in claim 13, wherein said light-to-electrical power converter further comprises solar cells.

16. The system as recited in claim 13, wherein said power generated from said light-to-power converter is used to replace an advertising message displayed on the electrically replaceable display by a new advertising message, when the card and the card reader are decoupled.

17. The system as recited in claim 13, wherein said electrically replaceable display further comprises an e-paper type of display.

18. The system as recited in claim 13, wherein said card further comprises an energy storage unit and a switch.

19. The system as recited in claim 18, wherein said energy storage unit is a capacitor.

20. The system as recited in claim 18, wherein said energy storage unit stores a sufficient amount of energy for replacing a displayed advertising message on the electrically replaceable display by a new advertising message.
